(19) United States
(12) Patent Application Publication
(10) Pub. No.: US 2024/0296382 A1
(43) Pub. Date: Sep. 5, 2024

(54) METHOD AND ARRANGEMENTS FOR SUPPORTING VALUE PREDICTION BY A WIRELESS DEVICE SERVED BY A WIRELESS COMMUNICATION NETWORK

(71) Applicant: Telefonaktiebolaget LM Ericsson (publ), Stockholm (SE)

(72) Inventors: Min WANG, Luleå (SE); Jan CHRISTOFFERSSON, Luleå (SE); Bikramjit SINGH, Kirkkonummi (FI); Majid GERAMI, Lund (SE); Stefan WÄNSTEDT, Luleå (SE); Mårten ERICSON, Gammelstad (SE)

(21) Appl. No.: 18/571,391

(22) PCT Filed: Jun. 18, 2021
(86) PCT No.: PCT/SE2021/050606

§ 371 Date: Dec. 18, 2023

(51) Int. Cl. G06N 20/00; G06N 5/022; H04W 24/02

(52) U.S. Cl. CPC G06N 20/00; G06N 5/022; H04W 24/02

(57) ABSTRACT

Supporting value prediction by a first wireless device being served by a wireless communication network. The network sends, to the first wireless device, configuration information for configuring the first wireless device to, train a machine learning, ML, model to predict certain output values. The training uses input training data that at least partly are determined by operative conditions of the first wireless device and uses desired output values with the input training data. The training ends when the ML model being trained fulfills certain one or more ready criteria. The first wireless device trains the ML model based on the configuration information and sends reporting information to the network indicating that it has trained the ML model and fulfilled the ready criteria. The network determines, based on the reporting information, regarding application of the trained ML model by the first wireless device.

### TECHNICAL FIELD

Embodiments herein concern a methods and devices(s) for supporting value prediction by a wireless device being served by a wireless communication network, such as a telecommunications network.

### BACKGROUND

Communication devices such as wireless communication devices, that simply may be named wireless devices, may also be known as e.g. user equipments (UEs), mobile terminals, wireless terminals and/or mobile stations. A wireless device is enabled to communicate wirelessly in a wireless communication network, wireless communication system, or radio communication system, e.g. a telecommunication network, sometimes also referred to as a cellular radio system, cellular network or cellular communication system. The communication may be performed e.g. between two wireless devices, between a wireless device and a regular telephone and/or between a wireless device and a server via a Radio Access Network (RAN) and possibly one or more core networks, comprised within the cellular communication network. The wireless device may further be referred to as a mobile telephone, cellular telephone, laptop, Personal Digital Assistant (PDA), tablet computer, just to mention some further examples. Wireless devices may be so called Machine to Machine (M2M) devices or Machine Type of Communication (MTC) devices, i.e. devices that are not associated with a conventional user.

The wireless device may be, for example, portable, pocket-storable, hand-held, computer-comprised, or vehicle-mounted mobile device, enabled to communicate voice and/or data, via the RAN, with another entity, such as another wireless device or a server.

The wireless communication network may cover a geographical area which is divided into cell areas, wherein each cell area is served by at least one base station, or Base Station (BS), e.g. a Radio Base Station (RBS), which sometimes may be referred to as e.g. “eNB”, “eNodeB”, “NodeB”, “B node”, “gNB”, or BTS (Base Transceiver Station), depending on the technology and terminology used. The base stations may be of different classes such as e.g. macro eNodeB, home eNodeB or pico base station, based on transmission power and thereby also cell size. A cell is typically identified by one or more cell identities. The base station at a base station site may provide radio coverage for one or more cells. A cell is thus typically associated with a geographical area where radio coverage for that cell is provided by the base station at the base station site. Cells may overlap so that several cells cover the same geographical area. By the base station providing or serving a cell is typically meant that the base station provides radio coverage such that one or more wireless devices located in the geographical area where the radio coverage is provided may be served by the base station in said cell. When a wireless device is said to be served in or by a cell this implies that the wireless device is served by the base station providing radio coverage for the cell. One base station may serve one or several cells. Further, each base station may support one or several communication technologies. The base stations communicate over the air interface operating on radio frequencies with the wireless device within range of the base stations.

In some RANs, several base stations may be connected, e.g. by landlines or microwave, to a radio network controller, e.g. a Radio Network Controller (RNC) in Universal Mobile Telecommunication System (UMTS), and/or to each other. The radio network controller, also sometimes termed a Base Station Controller (BSC) e.g. in GSM, may supervise and coordinate various activities of the plural base stations connected thereto. GSM is an abbreviation for Global System for Mobile Communication (originally: Groupe Special Mobile), which may be referred to as 2nd generation or 2G.

UMTS is a third generation mobile communication system, which may be referred to as 3rd generation or 3G, and which evolved from the GSM, and provides improved mobile communication services based on Wideband Code Division Multiple Access (WCDMA) access technology. UMTS Terrestrial Radio Access Network (UTRAN) is essentially a radio access network using wideband code division multiple access for wireless devices. High Speed Packet Access (HSPA) is an amalgamation of two mobile telephony protocols, High Speed Downlink Packet Access (HSDPA) and High Speed Uplink Packet Access (HSUPA), defined by 3GPP, that extends and improves the performance of existing 3rd generation mobile telecommunication networks utilizing the WCDMA. Such networks may be named WCDMA/HSPA.

The expression downlink (DL) may be used for the transmission path from the base station to the wireless device. The expression uplink (UL) may be used for the transmission path in the opposite direction i.e. from the wireless device to the base station.

In 3rd Generation Partnership Project (3GPP) Long Term Evolution (LTE), base stations, which may be referred to as eNodeBs or eNBs, may be directly connected to other base stations and may be directly connected to one or more core networks. LTE may be referred to as 4th generation or 4G.

The 3GPP has undertaken to evolve further the UTRAN and GSM based radio access network technologies, for example into evolved UTRAN (E-UTRAN) used in LTE.

3GPP has specified and development work continues with a fifth generation (5G) wide are wireless communication networks, and even development with a further generation has begun.

Mobile broadband drives the demands for higher overall traffic capacity and higher achievable end-user data rates in wireless access networks, including for such mentioned above. Future scenarios are expected to require data rates of up to 10 Gbps in local areas. These demands for very high system capacity and very high end-user date rates can be met by networks with distances between access nodes ranging from a few meters in indoor deployments up to roughly 50 m in outdoor deployments, i.e. with an infra-structure density considerably higher than the densest networks of today. The wide transmission bandwidths needed to provide data rates up to 10 Gbps and above can likely only be obtained from spectrum allocations in the millimetre-wave bands. High-gain beamforming, typically realized with array antennas, can be used to mitigate the increased pathloss at higher frequencies. This is for example relevant for New Radio (NR) based systems mentioned in the following, as defined by 3GPP for use with e.g. 5G.

NR systems should support a diverse set of use cases and a diverse set of deployment scenarios. The latter includes deployment at both low frequencies (in magnitudes hundreds MHZ) and very high frequencies (in magnitudes tens of GHz). Two operation frequency ranges (FR) are defined in 3GPP NR Release 15: FR1 from 410 MHZ to 7125 MHz and FR2 from 24.250 GHz to 52.6 GHz. 3GPP RAN is for 3GPP NR Release 17 studying how to best support NR operation on FR2 frequencies, i.e. from 52.6 GHz to 71 GHz, see 3GPP TS 38.321, V 16.0.0.A study item includes the following objectives:
Study of required changes to existing NR using existing DL/UL NR waveform to support operation between 52.6 GHz and 71 GHz.
Study of applicable numerology including subcarrier spacing, channel BW (including maximum BW), and their impact to FR2 physical layer design to support system functionality considering practical RF impairments.
Identify potential critical problems to physical signal/channels, if any.
Study of channel access mechanism, considering potential interference to/from other nodes, assuming beam-based operation, in order to comply with the regulatory requirements applicable to unlicensed spectrum for frequencies between 52.6 GHz and 71 GHz.

Similar to LTE, NR as specified by 3GPP uses Orthogonal Frequency Division Multiplexing (OFDM) in the downlink, i.e. for transmission from a network node, e.g. gNB, eNB, or base station, to a user equipment or UE, i.e. a wireless communication device operating with and served by the network.

The basic NR physical resource over an antenna port can thus be seen as a time-frequency grid. A resource block (RB) is a slot of 14-symbols in the time domain. A resource block further corresponds to 12 contiguous subcarriers in the frequency domain. Resource blocks are numbered in the frequency domain, starting with 0 from one end of the system bandwidth. Each resource element corresponds to one OFDM subcarrier during one OFDM symbol interval. Different subcarrier spacing values are supported in NR. The supported subcarrier spacing values (also referred to as different numerologies) are given by Δf=(15×2\hat{ }μ) kHz where μ∈(0,1,2,3,4). Δf=15 kHz is the basic, or reference, subcarrier spacing that is also used in LTE.

In the time domain, downlink and uplink transmissions in NR will be organized into equally-sized subframes of 1 ms, each similar to LTE. A subframe is further divided into multiple slots of equal duration.

There is only one slot per subframe for Δf=15 kHz and a slot consists of 14 OFDM symbols.

Downlink transmissions are dynamically scheduled, where in each slot the gNB transmits downlink control information (DCI) about which UE data is to be transmitted to and which resource blocks in the current downlink slot the data is transmitted on. This control information is typically transmitted in the first one or two OFDM symbols in each slot in NR. The control information is carried on the Physical Control Channel (PDCCH) and data is carried on the Physical Downlink Shared Channel (PDSCH). A UE first detects and decodes PDCCH and if a PDCCH is decoded successfully, it then decodes the corresponding PDSCH based on the downlink assignment provided by decoded control information in the PDCCH.

In addition to PDCCH and PDSCH, there are also other channels and reference signals transmitted in the downlink, including SSB, CSI-RS, etc.

Uplink data transmissions, carried on Physical Uplink Shared Channel (PUSCH), can also be dynamically scheduled by the gNB by transmitting DCI. The DCI, which is transmitted in the DL region, indicates a scheduling time offset so that the PUSCH is transmitted in a slot in the UL region.

Buffer status report (BSR) carry information on the amount of data available for transmission in the UL, e.g. from UE to gNB. This is a way to signal to the network the amount of data available at UE for transmission in the UL and for which UL resources and UL grant is requested. To avoid delay, BSR is typically send in the first UL grant allocation received after sending a scheduling request (SR). Thanks to the BSR, the network, or more particularly the gNB serving the UE, gets informed of the amount of data pending at UE and can send UL grant allocations based on it.

A number of techniques have been proposed in the prior art to try to avoid the overhead that comes from the SR/BSR grant negotiation as indicated above. Some examples are:
Semi-persistent scheduling (SPS) which means that a the gNB provides a grant that is valid for a long period of time. This works well as long as the UE transmits data with similar inter-arrival time (IAT) and packet size, while at the same time not moving very much, since the choice of multiplexing and coding schemes (MCS) are limited during semi-persistent scheduling.
WiFi-like transmissions are contention-based transmissions where the UE is allowed to transmit UL data at any time as long as neighbor devices do not transmit, i.e. the UE has to listen before transmission (LBT). In case there are very many UEs in an area, LBT is not very efficient since the waiting time until transmission may become very large.
Pre-scheduling is a method where the gNB provides resources in advance, assuming that the UE will send at some point in the near future. If the UE does not send the assigned resources are wasted. SPS is a form of pre-scheduling.

### SUMMARY

In view of the above, an object is to enable or provide one or more improvements or alternatives in relation to the prior art, such as to enable or provide one or more improvements regarding the BSR and/or SR overhead and latency.

According to a first aspect of embodiments herein, the object is achieved by a method, performed by one or more network nodes, for supporting value prediction by a first wireless device being served by a wireless communication network. Said one or more network nodes send, to the first wireless device, configuration information for configuring the first wireless device to, during operation with the wireless communication network, train a machine learning (ML) model to predict certain output values. The training uses certain input training data that at least partly are determined by operative conditions of the first wireless device and uses certain desired output values with the input training data. Said training ends when the ML model being trained fulfills certain one or more ready criteria. The one or more network nodes receive, from the first wireless device, reporting information at least indicating that the first wireless device has trained the ML model and fulfilled said certain one or more ready criteria. The one or more network nodes determine, based on the received reporting information, regarding application of the trained ML model.

According to a second aspect of embodiments herein, the object is achieved by a computer program comprising instructions that when executed by one or more processors causes one or more network nodes to perform the method according to the first aspect.

According to a third aspect of embodiments herein, the object is achieved by a carrier comprising the computer program according to the second aspect.

According to a fourth aspect of embodiments herein, the object is achieved by a method, performed by a first wireless device, for supporting value prediction by the first wireless device. The first wireless device being served by a wireless communication network. The first wireless device receives, from one or more network nodes of the wireless communication network, configuration information for configuring the first wireless device to, during operation with the wireless communication network, train a ML model to predict certain output values. The training uses certain input training data that at least partly are determined by operative conditions of the first wireless device and uses certain desired output values with the input training data. Said training ends when the ML model being trained fulfills certain one or more ready criteria. The first wireless device trains the ML model based on the received configuration information until said certain one or more ready criteria are fulfilled. The first wireless device then sends, to one or more network nodes of the wireless communication network, reporting information at least indicating that the first wireless device has trained the ML model and fulfilled said certain one or more ready criteria.

According to a fifth aspect of embodiments herein, the object is achieved by a computer program comprising instructions that when executed by one or more processors causes a first wireless device to perform the method according to the fifth aspect.

According to a sixth aspect of embodiments herein, the object is achieved by a carrier comprising the computer program according to the sixth aspect.

According to a seventh aspect of embodiments herein, the object is achieved one or more network nodes for supporting value prediction by a first wireless device being served by a wireless communication network. Said one or more network nodes are configured to send, to the first wireless device, configuration information for configuring the first wireless device to, during operation with the wireless communication network, train a ML model to predict certain output values. Said training uses certain input training data that at least partly are determined by operative conditions of the first wireless device and uses certain desired output values with the input training data. Said training ends when the ML model being trained fulfills certain one or more ready criteria. The one or more network nodes are further configured to receive, from the first wireless device, reporting information at least indicating that the first wireless device has trained the ML model and fulfilled said certain one or more ready criteria. Moreover, the one or more network nodes are further configured to determine, based on the received reporting information, regarding application of the trained ML model.

According to an eight aspect of embodiments herein, the object is achieved by a first wireless device for supporting value prediction by the first wireless device when being served by a wireless communication network. The first wireless device is configured to receive, from one or more network nodes of the wireless communication network, configuration information for configuring the first wireless device to, during operation with the wireless communication network, train a ML model to predict certain output values. Said training uses certain input training data that at least partly are determined by operative conditions of the first wireless device and uses certain desired output values with the input training data. Said training ends when the ML model being trained fulfills certain one or more ready criteria. The first wireless device is further configured to train the ML model based on the received configuration information until said certain one or more ready criteria are fulfilled. Moreover, the first wireless device is configured to send, to one or more network nodes of the wireless communication network, reporting information at least indicating that the first wireless device has trained the ML model and fulfilled said certain one or more ready criteria.

Embodiments herein offer value prediction through machine learning that can be used as an alternative to or in addition to conventional provision of the values being predicted, such as values used to provide BSR and/or SR, handover measurements and/or handover requests. As explained herein, the ML model can be trained to predict the output values before these are, or even can be, provided conventionally, and thereby e.g. provide improvements regarding BSR and/or SR overhead and latency as indicated in the Background. Embodiments herein may in short be described as relating to a flexible ML based method for value prediction controlled by the network, or by a serving radio network node such as base station, but performed by a wireless device. In other words, embodiments herein may be considered to relate to how the network can configure and control training and application of ML models that are trained and inferred by wireless devices.

Embodiments herein makes it possible for the network to take advantage of ML in wireless devices when possible and suitable, such as only when the network considers that it would be advantageous from a network perspective and so that the ML is not only applied from perspective of individual wireless devices. However, if the ML would be performed in and by the network, it would require much more signaling and likely would cause undesirable delays. This since the network do not have access to the same inputs and is not affected by the same conditions and environment as a wireless device, which inputs etc. are relevant when output values from the wireless device shall be predicted. Moreover, when the actual ML training and inference, i.e. application of the trained ML model, is performed by individual wireless devices, such as when embodiments herein are applied, requirements on the network are relaxed compared to if the network itself would perform ML, e.g. per wireless device.

Further, with the network in control of the ML as provided by embodiments herein, and since the network, and serving radio network node, is shared between wireless devices, suboptimization can be avoided. Suboptimization can else easily occur if each wireless device alone would control and apply ML, and only take into account how itself is affected by application of the trained model, even though this could cause negative effect elsewhere and from a network perspective. The network or radio network node can receive and evaluate predicted, possibly also actual output values, from one or more other, such as second, wireless devices, being served. Similarly as for the first wireless device, these second wireless devices may be configured and controlled by the network and the network may similarly receive reporting information from the second wireless devices etc. The network and/or radio network node can thereby take into consideration a total, or sum, effect when configuring training and/or determine regarding application of trained ML models, and thereby avoid suboptimization. Further, based on embodiments herein, the network can share and reuse trained ML models and parameters among wireless devices, e.g. to assist and enable shortened training period(s).

### BRIEF DESCRIPTION OF THE DRAWINGS

Examples of embodiments herein are described in more detail with reference to the appended schematic drawings, which are briefly described in the following.

FIG. 1 is a block diagram schematically depicting an exemplary wireless communication network in relation to which embodiments herein may be implemented and utilized.

FIG. 2 is a combined signaling diagram and flowchart for describing and discussing some examples and embodiments herein

FIG. 3 is a flowchart schematically illustrating embodiments of a method, performed by one or more network nodes, according to embodiments herein.

FIG. 4 is a schematic block diagram for illustrating embodiments of how one or more network nodes may be configured to perform the method and actions discussed in connection with FIG. 3.

FIG. 5 is a flowchart schematically illustrating embodiments of a method, performed by a first wireless device, according to embodiments herein.

FIG. 6 is a schematic block diagram for illustrating embodiments of a first wireless device may be configured to perform the method and actions discussed in connection with FIG. 5.

FIG. 7 is a schematic drawing illustrating some embodiments relating to computer program(s) and carriers thereof to cause one or more network nodes and/or a first wireless device to perform the method and related actions discussed in connection with FIGS. 3 and 5.

### DETAILED DESCRIPTION

Throughout the following description similar reference numerals may be used to denote similar elements, units, modules, circuits, nodes, parts, items or features, when applicable. Features that appear only in some embodiments are, when embodiments are illustrated in a figure, typically indicated by dashed lines.

Embodiments herein are illustrated by exemplary embodiments. It should be noted that these embodiments are not necessarily mutually exclusive. Components from one embodiment may be tacitly assumed to be present in another embodiment and it will be obvious to a person skilled in the art how those components may be used in the other exemplary embodiments.

As part of the development of embodiments herein, the situation indicated in the Background will first be further elaborated upon.

If a BSR could be predicted with sufficient accuracy in advance, i.e. before the actual BSR is provided according to conventional functionality, said overhead and latency caused by the conventional SR/BSR grant negotiation could be reduced. It can further be realized that there is dependency between operative conditions of a UE and the data to be transmitted in the uplink, and also in the downlink. Operative conditions here e.g. include such caused by user behavior, user triggered UE events, due to the UE location, due to time of the day/week, transmission history in uplink and/or downlink, radio conditions, UE environment etc. A large number of variables can be formed and used to identify, indicate and/or measure such conditions. An input data set with a relatively large amount of such variables could be formed. In theory relationships to output value could be provided by means of regression analysis. However, the number and variation of different types of variable make conventional methods for regression analysis unsuitable. Instead machine learning (ML) would be better choice. ML has successfully been applied in similar situations instead of conventional methods for regression analysis.

Various ML techniques have been known for quite some time and are increasingly applied for solving various problem. In practise, it is not until lately computers have been powerful and sufficiently cost efficient to make it worthwhile to consider ML based solutions for many problems. As should be known to the skilled person, a basic principle of ML is that a computer, or in general device or apparatus with computing and data processing capabilities, can learn patterns and relationships and how output values can be predicted from input values, such as values of variables mentioned above. The learning, or training, is about training a suitable ML model, i.e. ML algorithm, for example based on a neural network but also other ML models exist, using predefined input and output values for the training, which may be referred to as training data and/or or stimuli for training. For a situation with input variables as above that may correlate with BSR, a ML model can be trained using input training data corresponding to values that the variables have attained during operation of the UE at some time, or during some time period, before conventional functionality have, or even could have, provided BSR values, i.e. values that are used to form the BSR. As output training data, here corresponding to desired output values to be used with the input training data values, the actual BSR values according to the conventional functionality can be used. If the input variables for the ML model does not have to wait for the input required by the conventional functionality, e.g. actual data in buffer, to provide the actual BSR values, the model can be trained to predict BSR values at some accuracy before they are provided by the conventional functionality. With a setup like this, training data resulting from normal operation of a UE can be used. The training is advantageously performed by the UE and the trained model applied by the UE.

It has further been realized that although the SR/BSR overhead problem mentioned above was the problem resulting in a solution according to embodiments herein, the solution can be applied to also many other situations where it is beneficial if a UE would be able to predict some values faster, e.g. in advance of actual values provided by a conventional functionality. This may be of particular interest for values that are to be sent to the network by the UE, or where the UE uses the values to send information to the network, and in particular where the network then will use the information to serve the UE. Another example is handover (HO) signaling where a UE performs measurements that may trigger the UE to send a HO request with measurement based values to the network so that the network will prepare and make sure that a HO is performed when needed. In some situations it is critical that a HO is performed fast, else radio link failure (RLF) may occur. Hence, it would be beneficial if predictions of coming HO and/or measurement values thereof could be predicted so that at least preparation for HO can be performed in advance and HO be performed faster.

In general, existing ML approaches can be categorized in 3 different categories depending on the nature of the “signals” or “feedback” involved in the training:
Supervised learning: When training a model, the computer is presented with example inputs and their desired outputs, usually from measurements, and the goal is a general rule that maps inputs to outputs, i.e., similar to regression analysis. During training the computer receives feedback that quantifies how well the model fits the data. In this case the user decides what the computer should learn.
Unsupervised learning: the learning algorithm by itself finds the structure in its input. Unsupervised learning can be a goal in itself, e.g., discovering hidden patterns in data. Perhaps this is the method with the largest potential for AI applications in the future, since it provides an opportunity to create models and patterns in the data set without having an idea of the expected output.
Reinforcement learning: A computer program interacts with a dynamic environment in which it must perform a certain goal (such as driving a vehicle or playing a game against an opponent). As it navigates its problem space, the program is provided feedback that is analogous to rewards, which it tries to maximize.

As should be recognized by the skilled person from explanation of and details about embodiments herein, embodiments herein are at least suitable for use with supervised learning and with some adaptation that is within the capacity of the skilled person, also with reinforcement leaning.

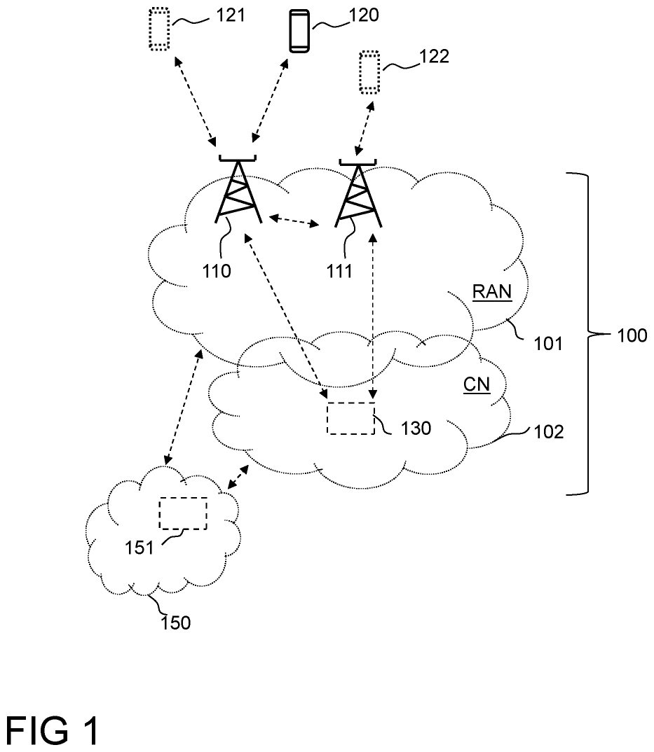

FIG. 1 is a block diagram schematically depicting a wireless communication network 100 in which embodiments herein may be implemented and utilized.

The wireless communication network 100 may comprise a Radio Access Network (RAN) 101 part and a Core Network (CN) 102 part. The wireless communication network 100 may be a telecommunication network or system, such as a cellular communication network that supports at least one Radio Access Technology (RAT), e.g. LTE, or 4G, and/or 5G, and New Radio (NR) based systems in general, including e.g. also further generations beyond 5G

The wireless communication network 100 typically comprises network nodes that are communicatively interconnected. The network nodes may be logical and/or physical and are located in one or more physical devices. The wireless communication network 100, typically the RAN 101, comprises one or more radio network nodes, e.g. radio network nodes 110, 111 as shown in the figure. The radio network nodes 110, 111 are or comprise radio transmitting and/or receiving network nodes, such as base stations and/or are or comprises controlling nodes that control one or more radio transmitting and/or receiving network nodes. The radio network nodes 110, 111 are configured to serve and/or control and/or manage one or more wireless communication devices. Each radio network node provide one or more radio coverages, e.g. corresponding to one or more radio coverage areas, i.e. radio coverage that enables communication with one or more wireless communication devices. A wireless communication device may alternatively be named a wireless device and it may correspond to a UE etc. as mentioned in the Background Each radio coverage may be provided by and/or associated with a particular Radio Access Technology (RAT). Each radio coverage area may correspond to a so called cell or a radio beam, that simply may be named a beam. As should be recognized by the skilled person, a beam is a more dynamic and relatively narrow and directional radio coverage compared to a conventional cell, and may be accomplished by so called beamforming. A beam is typically for serving one or a few communication devices at the same time, and may be specifically set up for serving one or few communication devices. The beam may be changed dynamically by beamforming to provide desirable coverage for the one or more wireless communication devices being served by the beam. There may be more than one beam provided by one and the same radio network node.

Said radio network nodes 110, 111 may e.g. be communicatively connected, such as configured to communicate, over, or via, a certain communication interface and/or communication link.

Further, the wireless communication network 100, or rather the CN 102, typically comprises one or more core network nodes, e.g. a core network node 130 as shown in the figure. These may be communicatively connected to each other and other network nodes, such as configured to communicate, over, or via, a communication interface and/or communication link, with radio network nodes of the RAN 101, e.g. with the radio network nodes 110, 111.

The figure also shows wireless communication devices, a first wireless communication device 120, and second wireless devices 121, 122, for communication with and via the wireless communication network 100, e.g. by being served by the wireless communication network 100 by means of one or more radio network nodes, e.g. the radio network node 110 and/or radio network node 111, when within radio coverage. The figure shows a situation where the wireless devise 120, 121 are served by the radio network node 110 and the wireless device 122 is served by the radio network node 111. Radio communication between a wireless device and a radio network nodes of the wireless communication network takes part over one or more radio channels therebetween.

The figure also shows a further node 151 and a further network 150. The further node 151 may be located outside the wireless communication network 100, i.e. be an external node, as indicated in the figure, or alternatively (not indicated in the figure) be comprised in the wireless communication network 100 and thus be a network node thereof, e.g. a management node thereof. The further network node 151 may in principle be any node communicatively connected to the wireless communication network 100, e.g. to support it in some way. Likewise, the further network 150 may be located outside the wireless communication network 100, i.e. be an external network, as indicated in the figure, e.g. corresponding to a so-called computer cloud, often simply referred to as cloud, that may provide and/or implement services and/or functions for and/or relating to the wireless communication network 100. The further network 150 may alternatively (not indicated in the figure) be comprised in the wireless communication network 100 and thus e.g. correspond to a subnetwork thereof. It is implied that a network, e.g. an one of the wireless communication network 100 and the further network 150, comprises interconnected network nodes. The further network 150 and further network node 151 may in principle be any network and network node communicatively connected to the wireless communication network.

Embodiments herein relate to actions performed by one or more wireless devices, e.g. the wireless device 120, and actions performed by a wireless communication network, e.g. the wireless communication network 100, in practice by one or more network nodes thereof, e.g. the radio network node 110, possibly with support of one or more further network nodes and/or networks and/or devices, e.g. one or more of the radio network node 111, the core network node 130, the further network 150 and further network node 151.

Attention is drawn to that FIG. 1 is only schematic and for exemplifying purpose and that not everything shown in the figure may be required for all embodiments herein, as should be evident to the skilled person. Also, a wireless communication network or networks that correspond(s) to the wireless communication network 100, will typically comprise several further network nodes, such as further radio network nodes, e.g. base stations, network nodes, e.g. both radio and core network nodes, etc., as realized by the skilled person, but which are not shown herein for the sake of simplifying.

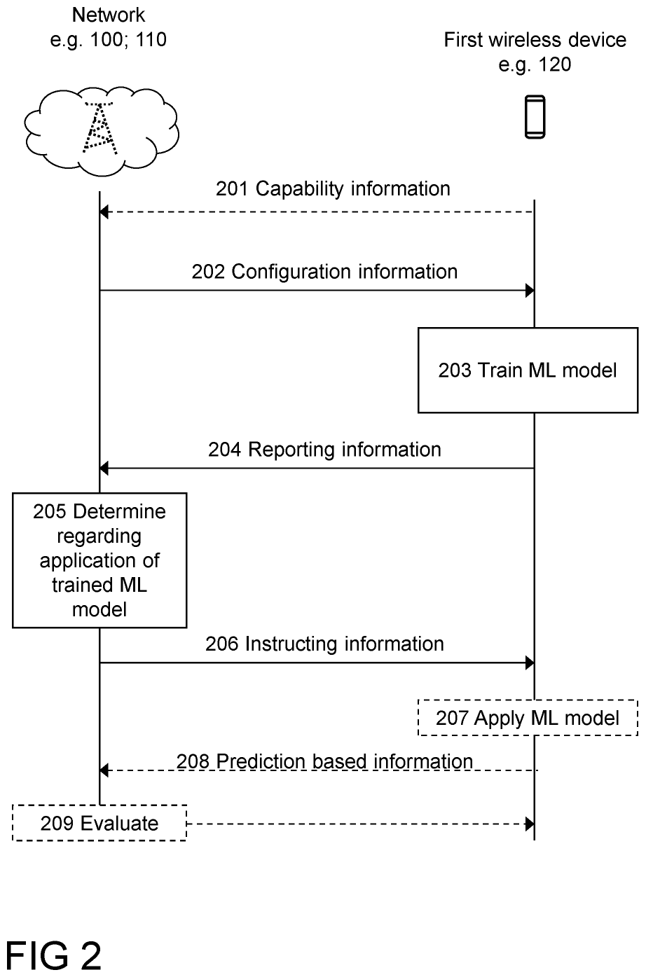

FIG. 2 is a combined signalling diagram and flowchart for describing and discussing some examples and embodiments herein relating to actions for supporting value prediction by a first wireless device served by a wireless communication network, or more particularly a radio network node thereof. Below, the first wireless device will be exemplified by the first wireless device 120, the wireless communication network by the wireless communication network 100 and the radio network node by the radio network node 110.

The actions below may be taken in any suitable order and/or be carried out fully or partly overlapping in time when this is possible and suitable.

### Action 201

The wireless device 120 may send capability information to the radio network node 110 that thus may receive such information.

The capability information is information informing about the capability of the wireless device 120 regarding training of ML models relevant for embodiment herein, e.g. information about one or more of the following: one or more ML models that are supported and can be trained, which type of output values that it can be trained to predict, which variables that are available for input to the ML model.

If it is not predetermined that each wireless device served by the wireless communication network 100 supports embodiments herein, the present action offers a way for the network to be informed if a wireless device supports and can be configured to perform actions below and thereby apply embodiments herein, and/or how it can be configured. For example, the radio network node 110 can through this action be informed if the wireless device 120 supports ML and/or certain ML models/algorithms. Further, the ability of a wireless device to predict at a certain accuracy during a certain period of time may depend on the hardware capabilities of the device, e.g., high capability wireless devices have higher memory, more processing power, some may be furnished with certain microchips adapted for implementing ML and/or AI solutions that make them particular suitable with embodiments herein, and may affect if/how the network should configure a wireless device according to embodiments herein.

In case the wireless communication network 100, e.g. the radio network node 110, does not know about capability of a wireless device, e.g. because it has not received capability signaling as in the present action, a default capability may be assumed. The default capability may be one of the following:
the wireless device doesn't support ML at all, or at least not support embodiments herein at all,
the wireless device supports some default ML models or ML algorithms compatible with embodiments here but that needs to be configured to be operable according to embodiments herein.

### Action 202

The radio network node 110 sends to the first wireless device 120, that receives, configuration information for configuring the first wireless device 120 to, during operation with the wireless communication network 100, train a ML model to predict certain output values, e.g. output values as indicated above and elsewhere herein. The training uses certain input training data, i.e. input to the model during the training, that at least partly should be determined by operative conditions of the first wireless device 120. The input training data may thus correspond to values of input variables for the ML model as discussed above. The input training data may relate to external signals input to and/or measured by the wireless device 120, or may relate to internal signal(s), states and/or values measured and/or obtained by the wireless device 120. Further, the training being configured uses certain desired output values with the input training data, i.e. corresponding to what the model is to be trained to predict. Moreover, the training being configured ends when the ML model being trained fulfills certain one or more ready criteria.

As indicated above under Action 201, the configuration information may be based on the capability information, i.e. in embodiments when the network receives capability information as in Action 201, the network would typically determine and/or send the configuration information based on the received capability information.

The configuration information may identify one or more of the following: the ML model to be trained, at least part of the input training data to be used during the training, one or more of the desired output values to be used during the training, one or more of said ready criteria, one or more training stop or paus criteria, one or more parameters of other trained ML models that have been trained by one or more other, second wireless devices, e.g. the second wireless devices 121 and/or 122. The other trained ML models should be ones compatible with and based on the same type of parameters as the ML model subject for the training by the first wireless device 120. Information regarding already trained models, e.g. parameter, may be used to enable shortened training until the ready criteria are met. Some or all of the info that may be comprised in the configuring information are in some embodiments instead known by the wireless device 120 in advance, e.g. by being predetermined. That is, the ML training may be enabled by information already known by the wireless device 120 and/or that the wireless device 120 gets from the configuration information. For example, in some embodiments, it may be predetermined that the output values are BSR values and that a ready criterium is that the model shall be able to predict BSR values×seconds (s) in advance of actual BSR values that may be provided according to a default, e.g. conventional, functionality for provision of BSR values. The configuring information may in this situation specify input training data and what desired output values are to be used for the training, and e.g. a further ready criterium, such as that predicted BSR values based on the input training data shall not diverge more than 1% from the actual BSR values, i.e. a criterium regarding accuracy.

The ML model used may as such specify input variables for the ML model, e.g. corresponding to certain measurements, or the ML model may allow for some flexibility in what input variables can be used with the ML model and the specific input variable to use may be specified by the configuration information. Input variables for the ML model and examples thereof are separately discussed and exemplified below.

The ML model, both if/when it is specified by the configuration information and/or is predetermined and already known by the wireless device 120, may be one or more ML models that are fully or partly predetermined, such as specified in advance e.g. in a standard specification.

The input training data may be a set of predetermined data, with e.g. values of input variables for the ML model, provided to the wireless device 120 and/or data available to the wireless device 120 when it is operative, e.g. corresponding to UE radio measurements or measurements on received signals affected by e.g. radio conditions, use conditions and/or status of the UE, the operative environment of the wireless device 120 etc.

Said one or more training stop or paus criteria, different from the ready criteria, are criteria that when fulfilled, makes the wireless device 120 stop or paus the training, despite that the ready criteria have not been met. Reason may be to reduce impact of the training on performance the wireless device and/or user experience associated with this. For example, if the wireless device 120 runs on battery and the battery level is below a certain level, the training may drain the last energy from the battery which may make it impossible to finalize the training according got the ready criteria, and/or make the training of less value. Hence it may be better to stop or paus the training in such situation. In some embodiments, at least part of the stop or paus criteria are predetermined and known in advance by the wireless device 120 and/or may, at least partly, be part of the configuration information as described above, and thereby controllable by the network. The network may utilize this to e.g. balance benefits from a trained model vs possible drawbacks that the training may have on performance of the wireless device 120 and/or user experience thereof. Said one or more parameters of other trained ML models may be provided to enable the training to start with a model that can be trained to fulfill the ready criteria sooner than else would be the case. Said other trained ML models may be such that have proven successful and/or provided useful results in operative situations that are same as, similar as and/or relevant for other reasons also for the first wireless device 120.

As already indicated above, at least part of the desired output values may be provided during the training by the first wireless device 120 according to a first functionality for providing output values, e.g. a default functionality for providing BSR values or HO triggering measurements.

The output values from the first functionality may be actual output values, i.e. output values that the trained model is trained to predict, e.g. BSR values or handover measurements. The first functionality may be a default, e.g. predetermined and/or conventional, functionality present in the first wireless device 120 for provision of actual output values (such to be predicted by the model). In some embodiments, the first functionality is instead according to another, e.g. previously trained and applied, ML model, i.e. may be functionality corresponding to inference of an earlier trained ML model and that may currently be in operative use for provision of predicted output values.

The prediction and training may be about being able to provide output values sooner than by the first operative functionality, or reducing the need of using the first operative functionality, or enable to use it less often, for example to save resources, or be able to reduce/avoid some signaling, or provide an alternative to the output values provided by the first functionality.

In these embodiments, both the model being trained and the first functionality, e.g. default functionality for providing BSR and that may be in operative use during the training, may provide output values, i.e. predicted output values from the model under training and output values by the first functionality. Accuracy and timing of output values predicted by the model under training can be evaluated in relation to the output values according to the first functionality.

Further, as also indicated above, the output values may be values for forming information that the first wireless device 120 is configured to transmit to the wireless communication network 100 when operating with the wireless communication network 100. This kind of output values may be of main interest to predict by embodiment herein. The output values may in other words be for operative use by the network. The reference to “output values” should here be understood to concern the actual output values (to be predicted), the desired output values for the training, and the predicted output values (if/when the trained model is applied).

The output values may be values required by the network from wireless devices, e.g. needed by the network to be able to operate or function as required. Examples of this kind of values are values that e.g. BSR, HO request are based on. For example, output values needed when the network 100 is serving, or for the network to be able to serve, wireless device(s), including e.g. the first wireless device 120 and/or other wireless device(s), such as the second wireless devices 121, 122. The other wireless device(s) may thus be such served by the same and/or other, e.g. neighboring, radio network node(s), as the radio network node 110 serving the first wireless device 120. Embodiments herein are particularly advantageous with this kind of output values since it is typically desirable to be able to provide these kind of values faster although it is very difficult, if not impossible, through conventional functionality.

The output values may thus be values for use by the wireless communication network 100 for serving the first wireless device 100.

Particularly, said output values may relate to one or more of the following: allocation of resources for transmission in the uplink and/or downlink, scheduling of resources in the uplink and/or downlink, handover regarding the first wireless device 120. For example, the prediction may be regarding values of, or values used for, the BSR, SR, handover signaling and/or handover measurements etc.

The configuration information may thus provide parameters and procedures to the wireless device 120, e.g. regarding said ready criteria that may include a prediction accuracy that thus may be set through said configuration information. As indicated, the criteria may also include other reasons for stopping the training, e.g. a ML training timer or device battery threshold that may stop the ML training if the wireless device has a too low power level according to the threshold, etc. The criteria are further discussed below in connection with Action 203.

The configuration signaling is typically not time critical and may be provided via Radio Resource Control (RRC), such as at RRC Connection Setup or RRC Connection modification.

### Action 203

The wireless device 120 trains the ML model based on the configuration information received in Action 202 until said certain one or more ready criteria are fulfilled. That is, the wireless device 120 trains the model according to the configuration information and as described above under Action 202. In other words, the training is according to how the wireless device 120 was configured by the network through the configuration information.

The ML model being trained until it fulfills certain one or more ready criteria may include that the model is trained until it is able to predict output values that fulfill a ready criterium or criteria.

Said one or more ready criteria is advantageously fully or partly comprised in or identified by said configuration information. This way the network can control and decide what is needed from the trained ML model, e.g. what accuracy is needed or desirable to reach. What exact this is can be determined by the network on a case by case and/or situational basis. Alternatively or additionally: Said one or more ready criteria may be separately obtained by the wireless device, e.g. information about it being separately sent from the network and received by the wireless device, and/or the ready criteria is predefined or predetermined, e.g. specified in a standard.

In some embodiments, some predefined or predetermined information, already known by the wireless device 120, are replaced by corresponding information received in the configuration information, and/or in some embodiments, the configuration information supplements such predefined or predetermined information. In some embodiments, the wireless device 120 received all information for configuring it for the ML training performed in the present action from the network in Action 202.

The training may be started as soon as possible after the configuration information has been received by the wireless deice 120, i.e. the configuration information may act as a trigger for the training and/or when the wireless device 120 has all information needed to start and perform the training. In some embodiments, the training may be configured to start some predetermined time after receiving the configuration information and/or when triggered by some other event that in turn may be configured by the configuration information or be predetermined. The wireless device 120 may train the ML model according to the configuration information until the ready criteria are met.

When there are multiple ready criteria, these may be of “and” and/or of “or” type, i.e. it may be that all of multiple criteria must be fulfilled for the trained model to be considered ready and the training to stop, and/or that at least one, or at least a certain set, of the criteria must be fulfilled. For example, it may be that a certain accuracy must have been reached for at least 90% of predictions during a certain time interval and/or that a certain time period has lapsed.

In some embodiments, the criteria relate to accuracy of predicted output values. That is, relate to accuracy of output values predicted by the model. For example the accuracy may be an accuracy that the network has determined, or is predetermined, to be sufficient to be able to use or benefit from using predicted output values, and that may have been communicated to the wireless device 120, e.g. through the configuration information in the previous action. In some embodiments, said accuracy is predefined or predetermined when performing the method.

In some embodiments, the criteria relate to timely provision of predicted output values. For example that predicted output values shall be provided within a certain time, e.g. within a certain predefined or predetermined time interval, absolute or relative, such as sooner than first data is provided according to said first functionality. For example, in the BSR case, so that predicted BSR at sufficient accuracy can be provided sufficiently in advance of actual BSR provided according to default first functionality, e.g. sufficiently in advance to make it beneficial to apply and use the predicted first data at said accuracy. This since e.g. accuracy in a predicted BSR can never be as good as the actual BSR that reflects the actual resource need.

Hence, the criteria may relate provision of the predicted output values to provision of actual output values provided by first wireless device 120 according to a first functionality, such as the first functionality mentioned above. The first functionality is thus another functionality than the functionality provided by the model being trained. For example, the criteria may relate to that the ML model being trained shall be able to predict output values so they can be provided faster than when the actual output values are provided according to the first functionality and/or with an accuracy that is sufficiently close to accuracy of corresponding actual output values provided according to the first functionality.

When the criteria comprise one or more criteria regarding prediction accuracy, these criteria may relate to one or more of the following:
That a minimum number of successful predictions, such as x % of N predictions, are within y % of the true outcome.
That the ML model has been trained on at least N observations.
That the ML model has been trained for a at least a certain time period, e.g. T time units.

There may be several levels of prediction accuracy and separate criteria for each level.

In some embodiments, prediction accuracy is verified with a verification data set, i.e. data different from a training set used for the training as such. How well the prediction fits the verification set, or in general accuracy, may be measured by a share, e.g. percentage, of correct predictions. The accuracy may be expressed through e.g. mean squared error (MSE) of prediction or R², i.e. R-squared, or similar statistical measure that represents the proportion of the variance for a variable, e.g. a dependent variable explained by an independent variable or variables in a regression model. MSE and R² may be considered example measures of how well the prediction fits the verification set. In case the ML model is used for classification, e.g. output values that correspond to letters, a way to establish the accuracy is simply to count correctly classified letters and relate this to the total, also including classification into wrong letters.

As implied above, in some embodiments, the criteria may be applied in more than one step, e.g. In two steps. For example, training may be performed a certain time period using first input training data and first desired output data for use with the first input training data, e.g. first training data set(s) provided by the network only for training purpose. When a first criterium or criteria is/are fulfilled, e.g. training performed during a certain time period, the resulting trained model may be tested, or validated, using other, different data for validation and using a second criterium or criteria. The data for validation may be provided as a second predetermined data set from the network or may be predefined by the network, e.g. based on “live” input data that the trained model is applied to and the result from the model is compared with what existing, first functionality, results in. If the trained model fulfills the second criterion, or criteria, e.g. sufficient accuracy in relation to the first functionality, the trained model is fulfilling also the second criterium, thereby fulfilling the ready criteria, considered valid and thus ready after the training. If not, it may return to training using the first, or other data set. Then after another training period, it may again be tested and validated using the second criteria or criterium, etc.

A further example follow separately below regarding a case with “two step” criteria.

The finished training, thus fulfillment of said one or more ready criteria, may correspond to that the wireless device 120, by means of the trained ML model, has accomplished a sufficient prediction accuracy and/or that a timer for training has expired.

### Action 204

The wireless device 120 sends to the radio network node 110, that receives, reporting information at least indicating that the first wireless device 120 has trained the ML model and that the model has fulfilled said certain one or more ready criteria.

The reporting information may identify and/or comprise one or more of the following: accuracy obtained by the trained ML model, one or more model parameters of the trained ML model, the trained ML model. Identification may be accomplished by that the reporting information comprises what is being identified, or through one or more identifiers that the network can use and be informed about the accuracy, the parameters and/or the trained ML model. Said parameters, i.e. resulting from the training, and/or the trained ML model, may be identified so they can be evaluated and/or (re)used by the network, e.g. used to configure other wireless devices to assist or reduce training needs for these In some embodiments, the parameters are sufficient for identifying the trained ML model, when e.g. the ML model is already known by the network except for the parameters resulting from the training. The obtained accuracy can be used by the network to decide on application or not of the ML model, for comparison with trained ML models from other wireless devices, and/or as reference for later evaluation of predicted output values in case on application of the trained ML model. The obtained accuracy may by accuracy that resulted in fulfillment of the ready criteria. The trained ML model, e.g. information that identifies it and/or is sufficient to apply it, typically involves at least parameters resulting from the training, may be sent with the reporting information to enable the network to learn from, and/or reuse, the ML model, or parts thereof, with other wireless devices.

### Action 205

The radio network node 110 determines, based on the received reporting information, regarding application of the trained ML model.

The radio network node 110 may determine that the wireless device 120 shall apply or not apply the trained ML model. If it is decided not to apply, it may be implied that the first wireless device 120 continue provide values that the trained model predict by other means, e.g. continue to provide such according to such first functionality mentioned above. It may alternatively involve that the first wireless device 120 shall apply or train a new ML model and/or modified version of the ML model that the reporting information was about. The determination may be further based on input from other wireless devices that may have been trained in parallel and finalized their training before the first wireless device 120 and reported about it to the network. The network may have decided that some parameter from such other trained ML model or a complete such model shall instead be used by the first wireless device 120, e.g. when/if the network considers such other trained ML model to likely provide better predictions.

Said determination regarding application of the trained ML model may thus further be based on other reporting information that the radio network node 110 (and/or the wireless communication network 100 it is part of) has received from one or more second wireless devices, e.g. the wireless devices 121 and/or 122. The other reporting information may relate to one or more other trained ML models that have been trained by said second wireless devices, respectively.

Further, said determination regarding application of the trained ML model may relate to one or more of the following:
determine to instruct the first wireless device 120 to apply the ML model and thereby provide predicted output values accordingly,
determine to instruct the first wireless device 120 regarding when to apply the trained ML model,
determine to instruct the first wireless device 120 to provide output values additionally or alternatively according to another functionality,
determine to instruct the first wireless device 120 to retrain the ML model.

Said another functionality may be said first functionality, e.g. default functionality for providing actual output values. If the trained models is determined not to be suitable for application, the network may instruct the first wireless device 120 to use, e.g. continue to use, the first functionality for providing output values. In some embodiments, even if the network has determined to apply the trained ML model, the network may instruct the wireless device 120 to provide both predicted output values according to the trained ML model and output values, e.g. actual output values, according to the first functionality. In some embodiments, the wireless device is configured to provide output values according to the first functionality, e.g. actual output values, irrespective and/or independent on what the network instructs regarding application of the trained ML model and thereby provision of predicted output values.

### Action 206

The radio network node 110 may, in response the determination regarding application of the trained ML model, send instructing information to the first wireless device 120, that thus may receive this information. The instructing information instructs the first wireless device 120 regarding application of the trained ML model.

Said instructing information may thus relate to, e.g. correspond to, what was determined in the previous action, i.e. what was determined regarding application of the trained ML model. The instructing information is a way for the network to inform and instruct the wireless device 120 so it can, and will, perform in accordance with what was determined. The wireless device 120 may be configured not to apply the trained ML model until explicitly instructed to do so by the network.

The present action may include that the radio network node 110 sends a command to the wireless device 120 to switch on the trained ML model. Such command may be in the form of a message that also can be used to switch off the trained ML model.

In some embodiments, the instruction information instructs the wireless device 120 to apply the model it has trained, in other embodiments is instructs the wireless device to fully or partly adjust the trained ML model, apply another model or functionality.

In some embodiments, the instructing information identifies one or more of the following:
one or more model parameters of another second trained ML model for replacing corresponding one or more model parameters of said ML model trained by the first wireless device 120,
another second trained ML model for replacing said ML model trained by the first wireless device 120.

In these embodiments, it may be implied and be triggered a new training by the wireless device 120 based on the new ML model and/or new model parameters.

Further, in these embodiments, said another second trained ML model is typically one that the radio network node 110 has been informed about via reporting information received from one or more second wireless devices as mentioned above under Action 205. That is, said another trained ML model may be one that has been trained by a second wireless device, e.g. any one of the wireless devices 121, 122.

For example, based on the above, the instructing information may relate to one or more of the following:
Requesting the wireless device 120 to apply the trained ML model, which may correspond to that the network confirms to the wireless device 120 that the trained ML model may or shall be used.
Requesting, e.g. recommending or instructing, the wireless device 120 to apply a different trained ML model than the trained ML model that the wireless device 120 trained and reported about.
Requesting, e.g. recommending or instructing, the wireless device 120 to use on or more other model parameters than of the trained ML model that the wireless device 120 trained and reported about.

In some embodiments, the network, e.g. the radio network node 110, may combine or integrate multiple trained ML models from different wireless devices into a single model. That is, use these ML models to form a single ML model that then is to be used by one or more wireless devices, e.g. instead of a ML model that a single wireless device has trained itself. However, in case several ML models are evaluated by the network, a simpler and preferred way may be to select the model considered best according to some criterium or criteria applied by the network, e.g. the one with best prediction accuracy, and let it be used by also other wireless device(s), i.e. other than the one that trained the model in question.

### Action 207

The wireless device 120 may, in response to the received instructing information, apply the trained ML model and thereby provide predicted output values according to it. As indicated above, this is typically the case when the instructing information in the previous action instructs, or commands, the wireless device 120 to apply the trained ML model. As also stated above, in some embodiments, the wireless device 120 may not be instructed at all, or be instructed not to apply the trained ML model, or to apply another ML model, and in these embodiments the wireless device 120 would typically not apply the trained ML model and thus not perform the present action. Applying the trained ML model in response to instructing information from the network enables the network to be able to check the trained model first and/or results from it, and thereby reduce the risk that the wireless device 120 itself would determine to apply the model, which may be beneficial from perspective of the wireless device 120, but not necessarily is so in view of information that the network have, e.g. in view of network exclusive information, and from a network perspective.

When the wireless device 120 applies the trained ML model it may in the BSR example case provide predicted BSR e.g. × ms prior to the arrival of data in a device buffer that conventionally would result in actual BSR according to a conventional functionality, such as a first functionality as discussed herein. The radio network node 110 can then use the predicted BSR and respond with a grant that provides resources for the UL transmission by the wireless device 120.

When or if the ML model trained by the wireless device 120 did not fulfill the ready criteria or if the network did not instruct the wireless device 120 to apply the trained ML model, in some embodiments, the network may still instruct the wireless device 120 to provide predicted values according to the trained model and e.g. send prediction based information based on the predicted values, such as in the next action below. This info may still be useful for the network although the network would use it differently in these embodiments compared to other embodiments.

Action 208 The wireless device 120 may send, to the radio network node 110, or other node(s) of the wireless communication network 100, that thus may receive, prediction based information. The prediction based information being information that is based on said predicted output values resulting from application of the trained ML model. In some embodiments, the prediction based information is predicted output values from the applied ML model. In other embodiments it is information, e.g. other values, data and/or message, based on, e.g. derived from, the predicted output values. The prediction based information can e.g. be BSR(s) or HO request message(s).

Action 209 The radio network node 110, or other node(s) of the wireless communication network 100, that receives prediction based information as in the previous action may evaluate this information. The evaluation may then be used to determined whether to use or not to use the received prediction based information and/or if the wireless device shall be instructed to stop applying the trained ML model and/or retrain it and/or modify it. Reason to evaluate it although the network already has determined to apply the trained ML model, is that the situation may change. That is, although application of the trained ML model was determined to be applied for a reason, e.g. since it was deemed to be beneficial, this may not be the case forever. It may therefore be advantageous to continuously or regularly, evaluate the prediction based information, e.g. its accuracy and/or benefits, such as by comparing it to corresponding or similar information provided by other means, e.g. based on or according to such first functionality as discussed above.

Thanks to embodiments herein and discussed above, that in short may be described as ML training and value prediction controlled by the network but performed by the first wireless device, the network can configure and control training and application of ML models trained and inferred by wireless devices. Since the network is shared between several, in principle all, wireless devices served by the wireless communication network, the network can correspondingly configure and control ML models and receive reporting information from also one or more other, such as second, wireless devices, as well as receive and evaluate predicted and/or actual output values from these wireless devices. The network can thus take into consideration a total, or sum, effect when configuring training and/or determine regrading application of a trained ML models and thereby be able to avoid or reduce risk for suboptimization as mentioned above, i.e. compared to if each wireless device alone and independently would control training and application of its own ML model.

In other words, the network can have control of for example prediction accuracy and can ensure that the predictions are not used until sufficient accuracy has been obtained. The network can ensure that predictions are not used by individual wireless devices to enhance their performance at the expense of system performance. The latter can be the case if individual wireless devices s were allowed to provide and send predicted BSRs biased towards high data rates for the wireless device only from its own perspective. Training and assessment of the ML model according to the ready criteria, performed by the wireless device itself instead of e.g. sending “test predictions” to the network, can at the same time reduce the network load during the training phase.

Input variables for the ML model and examples thereof will now be further discussed and exemplified with reference to the exemplifying first wireless device 120.

The input variables to the ML model may generally relate to any variable data or value that the wireless device 120 can measure and/or obtain values about. For example relating to radio parameters, mobility via variables with values that correlate with, e.g. map to, position of the wireless device, traffic parameters, etc. Time series of various measurements may be used as input variables to the prediction.

A traffic pattern associated with the wireless device 120, and that affects the output values to be predicted, may be used. Such traffic pattern may relate to, e.g. correlate with, can be identified by and/or be affected by, a set or number of different variables, e.g. radio measurements, applications being used, user behaviour of the user associated with the wireless device 120, e.g. if the user is stationary or mobile, device mobility pattern, e.g. if the device is held in a hand or is in a pocket, etc.

The user behaviour may in turn correlate with measurements and/or readings of radio conditions and/or sensors of the wireless device 120. There may also be a correlation between the user behaviour and the location of the wireless device.

In some embodiments, the ML model considers one or more statistics to determine its course of action, i.e. use one or more statistics as input variables. For example one or more of the following:
1. Radio condition statistics during a predefined or predetermined time-window
2. Radio condition statistics for specific location or a region relevant for the wireless device 120
3. Statistics regarding radio conditions experienced by nearby wireless devices, e.g. the second wireless devices 121, 122 (Nearby here refers to that they are within side-link coverage and/or are served, or covered, by the same and/or neighbouring radio network node(s), i.e. share radio coverage.)
4. Statistics applying weight(s) that may be affected by time or location, e.g. so that radio conditions experienced in the past have lesser impact than radio conditions experiences closer in time; and/or that radio conditions statistics collected from further away locations have less impact than radio conditions statistics collected from more nearby locations relative to the wireless device 120.

The above may be combined, e.g. if 1 and 2 are combined, the ML model may use input variables with values relating to radio conditions over a time-window for a specific location.

Attention is also drawn to that values of input variables, and in general measurement data/parameters, data measured/generated by a wireless device may also be used by other wireless device(s). That is, even though what the wireless device 120 experiences directly itself of course is relevant, in addition to this it can also be relevant and be used input regarding what other one or more wireless devices experience, typically at least nearby ones, e.g. the second wireless devices 121, 122. The wireless device 120 may receive such info via the network, e.g. the radio network node 110, or directly from nearby wireless devices via side-link. That is, the exchange may be via wireless devices directly or via radio network nodes serving them. Of course wireless devices involved are advantageously similar in one or more relevant aspects, additionally or alternatively to being nearby. For example, be of same or similar type or category, have similar traffic pattern(s), mobility state(s) etc.

Some more specific examples based on embodiments discussed above and relating to training of the ML model will now follow.

In a first example of training and verification, the ML model is applied to BSR case. The wireless device 120 uses its own buffer status over time together with also other input variables such as which applications are active, movement of the wireless deice 120, time of day, etc., to predict when a next BSR will be triggered or sent and the buffer status be reported by this BSR. It is predicted a probability that a BSR reporting more than X1 bytes will be triggered during next t time units, e.g. t milliseconds (ms). This is then compared to when the real BSR is triggered. Once the model is considered sufficiently accurate based on these ready criteria, this is notified to the network, e.g. to the radio network node 110, which then can order the wireless device 120 to apply the trained ML model and send predicted BSRs based on it, e.g. in addition to new actual BSRs. In this example, the wireless device 120 uses its own input variables. The input training data for these input variables correspond to actual values of the input variables during the training period. Thus the network needs not to send separate input training data to the wireless device 120 in this example.

As should be realized, the first example relate to Actions 202-205.

In a second example, the network, e.g. the radio network node 110, sends training data to the wireless device 120 over allocated signaling for this, e.g. PDSCH or DCI, that may be comprised in or identified by such configuration information as discussed above. The training data may correspond to dummy data to mimic data arrival in a buffer. To make the training data more realistic, it can be related to actual BSR reporting. The wireless device 120 may be instructed to prepare BSR reporting for the training data, called training BSR in the following, which thus is based on the ML model being trained and deployed at the wireless device 120. If the wireless device 120 trains several ML models, e.g. if there are N models, there may be prepared N training BSRs for the corresponding N models/algorithms. Over a period of time, the wireless device 120 may provide, and possibly also transmit, two types of BSRs, both training BSR (for which is no grant is provided as it corresponds to dummy training data) and actual, such as conventional or default, BSR (for which grant(s) will be provided based on actual data in the buffer). These two types of BSRs can be provided and possibly also sent at the same time or overlapping in time, or at different times. The network, e.g. the radio network node 110, may ensure over a period of time that the data volume for training BSR and actual BSR is approximately the same and can also verify if the training BSR, based on the ML model being trained, has a desirable advantage over the actual BSR. For example, verify if the trained ML model ensures that a number of training BSRs sent by the wireless device 120 is less than a number of actual BSRs for same approximate data volume. This is thus an example where the network is involved to find out if ready criteria regarding the training are fulfilled so that the wireless device 120 can stop the training of the ML model. When the ML model has been verified and ready criteria be met, and thus the ML model is considered sufficiently trained, the wireless device 120 may use the trained ML model to provide and report BSRs based on actual data in the buffer instead of training data.

Some further comments regarding the second example:

The network here do not use actual arrivals of data for the training BSR because the network does not typically know the arrivals of individual data packets in the wireless device 120 but only the timely BSR reporting which contains a sum of arrivals, i.e. a volume. A advantage with the network sending, and thus in control of and knowing, the training data is that the ML model can be trained with and made sensitive to arrival rate, pattern, etc. and provide output accordingly, including the training BSR.

Even though the network is involved during the training, it is still advantageous to train and test the ML model at the wireless device 120, since the wireless device 120 is in an environment and under conditions specific for it and that can impact the BSR and the grant, e.g., various kinds of traffic arrivals, traffic priorities, retransmissions, transmission failures due to channel impact, preemption/cancellation, dual or multi-connectivity with also other further radio network nodes.

As should be realized, also the second example relate to Actions 202-205.

BSR has mainly been used in examples including the first and second examples above. However, it is realized that methods and actions according to embodiments herein are applicable also in case of other output values than relating to BSR, for example regarding:
radio channel quality measurements of serving cells and neighbor cells
cell level measurements or beam level measurements
measurements in RRC connected or measurements in RRC IDLE or RRC INACTIVE states
uplink scheduling based on SR and BSR

In a third example, embodiments herein are applied for handover signaling and in particular prediction of triggered measurements. The wireless device 120 may be configured by the network, e.g. the radio network node 110, regarding measurement events related to handovers. An event triggered by such measurements will initiate handover and time is typically important. Assume for example that the wireless device 120 triggers a so called A3 event. This leads to that the wireless device 120 sends a measurement report to its serving base station, e.g. the radio network node 110. However, if the deterioration of the radio link is severe, the measurement report may never reach the network that thus cannot and will not send a HO command. This may lead to that the wireless device 120 triggers RLF. Alternatively, the network may actually receive the measurement report but due to fast deterioration of the radio coverage, the wireless device 120 never receives the HO command and also in this situation the result is RLF. Thanks to embodiments herein, a ML model for mobility can be trained and implemented. Input variables can be similar, and at least some be the same as in examples for BSR. It may be advantageous that the input variables relate to radio conditions in various locations, e.g. based on historical data and/or from other wireless devices. Other advantageous input variables may relate to mobility history, device usage and user mobility, and may enable faster actions, such as provision and sending of the measurement report earlier. Similarly, the ML model can include and be made to take into account information on processing time involved, e.g. to facilitate training of the ML model to provide sufficient, or at least improved, time for both measurement report and a HO command to be sent, whereby RLF can be avoided or that the risk for RLF is reduced.

Similar to the first and second examples, also the third example should be understood to relate to Actions 202-205.

A general approach when to apply embodiments in a specific situation may be according to the following. To find suitable input variables for the ML model, collected data, e.g. some summary statistics, may be analyzed, distributions may be studied and also variation over time since the data will be time series. A training data set can be formed based on the input variables, i.e. including input training data and desired output values to use with the input training data. The training data set should be representative for the specific situation and case, i.e. for which the output values are desired to be predicted, or in other words, be representative for the wanted result. For example, the training data set should not be limited to a specific time of the day if applicability outside this time is required since traffic varies during the day. The forming of the training data set may comprise decision on what to do with statistical outliers, e.g. whether to include or remove. Such decision is within the capacity of the skilled person given the specific circumstances. It can of course also be formed and tested different training data sets with and without such outliers. One or more verification data sets for the training may be formed in a similar way. The model can be trained until the ready criteria are reached and then evaluated, i.e. training may here be performed in a preprocessing, or initial, training stage, with the aim to improve and find more suitable input variables and training data. During such preprocessing or initial training it can be identified input variables and parameters that do not affect the model and that thus can be removed since there of course is no need to include more variables and training data than necessary. Results after performed initial training can be verified with verification data set(s) and when a model, input variables thereof and training data, are deemed good enough by the skilled person, the ML model and training data can be applied according to embodiments herein.

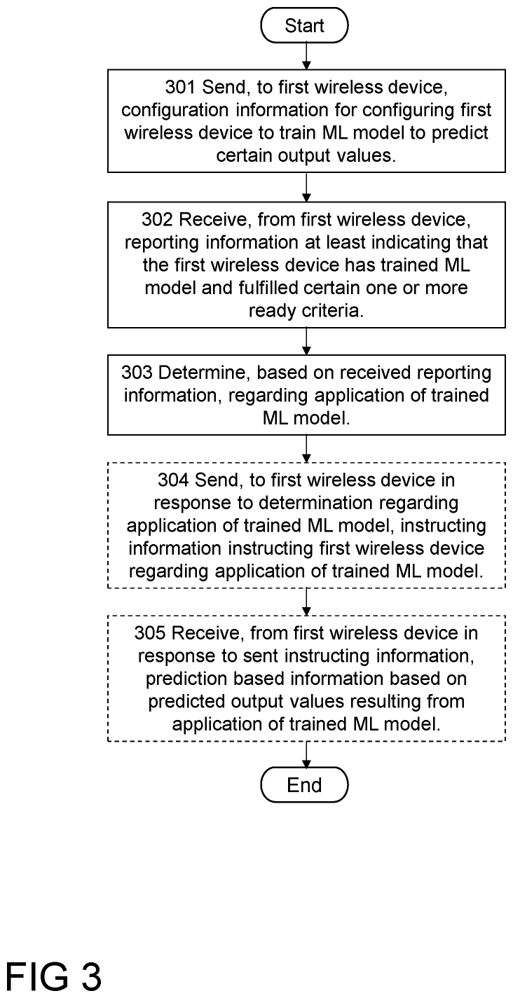

FIG. 3 is a flowchart schematically illustrating embodiments of a method according to embodiments herein. The method is for supporting value prediction by a first wireless device being served by a wireless communication network. In the following, the first wireless device will be exemplified by the first wireless device 120 and the wireless communication network will be exemplified by the wireless communication network 100.

The method may be performed by the wireless communication network 100 or one or more network nodes thereof, e.g. the radio network node 110, alone or with support of one or more further network nodes or devices, e.g. one or more of the radio network node 111, the core network node 130, the further network 150 and further network node 151. In the following, the method will be exemplified as it is performed by the radio network node 110.

The actions below that may form the method may be taken in any suitable order and/or be carried out fully or partly overlapping in time when this is possible and suitable.

### Action 301

The radio network node 110 sends, to the first wireless device 120, configuration information for configuring the first wireless device 120 to, during operation with the wireless communication network 100, train a machine learning, ML, model to predict certain output values. The training uses certain input training data that at least partly are determined by operative conditions of the first wireless device 120 and uses certain desired output values with the input training data. The training ends when the ML model being trained fulfills certain one or more ready criteria.

The configuration information may identify one or more of the following:
the ML model to be trained, at least part of the input training data to be used during the training,
one or more of the desired output values to be used during the training, one or more of said ready criteria,
one or more training stop or paus criteria, one or more parameters of other trained ML models that have been trained by one or more other, second wireless devices, e.g. the second wireless device 121 and/or 122, and which other trained ML models are compatible with and based on the same type of parameters as the ML model subject for the training by the first wireless device 120.

In some embodiments, at least part of the desired output values are provided during the training by the first wireless device 120 according to a first functionality for providing output values.

In some embodiments, the output values may be values for forming information that the first wireless device 120 is configured to transmit to the wireless communication network 100 when operating with the wireless communication network 100. The output values may be values for use by the wireless communication network 100 for serving the first wireless device 120.

The output values may relate to one or more of the following:
allocation of resources for transmission in the uplink and/or downlink,
scheduling of resources in the uplink and/or downlink,
handover regarding the first wireless device 120.

The ready criteria may relate to accuracy of predicted output values and/or to timely provision of predicted output values.

In some embodiments, the ready criteria relate provision of the predicted output values to provision of actual output values provided by the first wireless device 120 according to a first functionality, e.g. the first functionality mentioned above.

The present action may fully or partly correspond to Action 202.

### Action 302

The radio network node 110 receives, from the first wireless device, reporting information at least indicating that the first wireless device 120 has trained the ML model and fulfilled said certain one or more ready criteria. In some embodiments, said reporting information identifies one or more of the following: accuracy obtained by the trained ML model, one or more model parameters of the trained ML model, the trained ML model.

The present action may fully or partly correspond to Action 204.

### Action 303

The radio network node 110 determines, based on the received reporting information, regarding application of the trained ML model.

The present action may fully or partly correspond to Action 205.

### Action 304

In some embodiments, the radio network node 110 sends, to the first wireless device 120 in response to the determination regarding application of the trained ML model, instructing information instructing the first wireless device 120 regarding application of the trained ML model.

Said determination regarding application of the trained ML model and the instructing information may relate to one or more of the following:
instructing the first wireless device 120 to apply the ML model and thereby provide predicted output values accordingly,
instructing the first wireless device 120 regarding when to apply the trained ML model,
instructing the first wireless device 120 to provide output values additionally or alternatively according to another functionality,
instructing the first wireless device 120 to retrain the ML model.

Moreover, in some embodiments, said determination regarding application of the trained ML model is further based on other reporting information that the radio network node 110 have received from one or more second wireless devices, e.g. the second wireless devices 121 and/or 122, relating to one or more other trained ML models that have been trained by said second wireless devices, respectively.

In some embodiments, the instructing information further identifies one or more of the following:
one or more model parameters of another second trained ML model, comprised in said other trained ML models, for replacing corresponding one or more model parameters of said ML model trained by the first wireless device 120,
another second trained ML model, comprised in said other trained ML models, for replacing said ML model trained by the first wireless device 120.

The present action may fully or partly correspond to Action 206.

### Action 305

In some embodiments where the instructing information instructs the first wireless device 120 to apply the trained ML model, the radio network node 110 receives, from the first wireless device 120 in response to the sent instructing information, prediction based information. The prediction based information being information based on predicted output values resulting from application of the trained ML model by the first wireless device 120.

The present action may fully or partly correspond to Action 208.

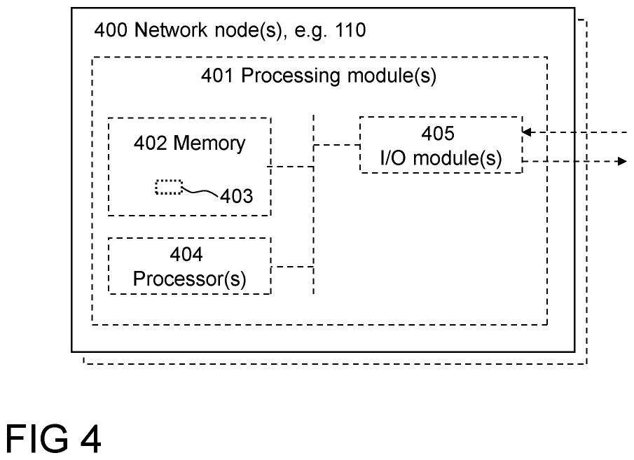

FIG. 4 is a schematic block diagram for illustrating embodiments of how one or more network nodes 400 may be configured to perform the method and actions discussed above in connection with FIG. 3. Hence, said network node(s) 400 are for supporting value prediction by the first wireless device 120 being served by the wireless communication network 100.

The network node(s) 400 may comprise processing module(s) 401, such as a means, one or more hardware modules, including e.g. one or more processors, and/or one or more software modules for performing said method and/or actions.

The network node(s) 400 may further comprise memory 402 that may comprise, such as contain or store, computer program(s) 403. The computer program(s) 403 comprises ‘instructions’ or ‘code’ directly or indirectly executable by the network node(s) 400 to perform said method and/or actions. The memory 402 may comprise one or more memory units and may further be arranged to store data, such as configurations and/or applications involved in or for performing functions and actions of embodiments herein.

Moreover, the network node(s) 400 may comprise processor(s) 404, i.e. one or more processors, as exemplifying hardware module(s) and may comprise or correspond to one or more processing circuits. In some embodiments, the processing module(s) 401 may comprise, e.g. ‘be embodied in the form of’ or ‘realized by’ processor(s) 404. In these embodiments, the memory 402 may comprise the computer program 403 executable by the processor(s) 404, whereby the network node(s) 400 is operative, or configured, to perform said method and/or actions thereof.

Typically the network node(s) 400, e.g. the processing module(s) 401, comprises Input/Output (I/O) module(s) 405, configured to be involved in, e.g. by performing, any communication to and/or from other network nodes and/or units and/or devices, such as sending and/or receiving information to and/or from other network nodes. The I/O module(s) 405 may be exemplified by obtaining, e.g. receiving, module(s) and/or providing, e.g. sending, module(s), when applicable.

Further, in some embodiments, the network node(s) 400, e.g. the processing module(s) 401, comprises one or more of an sending module(s), receiving module(s), determining module(s), as exemplifying hardware and/or software module(s) for carrying out actions of embodiments herein. These modules may be fully or partly implemented by the processor(s) 404.

### Hence:

The network node(s) 400, and/or the processing module(s) 401, and/or the processor(s) 404, and/or the I/O module(s) 405, and/or the sending module(s) are operative, or configured, to send, to the first wireless device 120, said configuration information.

The network node(s) 400, and/or the processing module(s) 401, and/or the processor(s) 404, and/or the I/O module(s) 405, and/or the receiving module(s) are operative, or configured, to receive, from the first wireless device 120, said reporting information.

The network node(s) 400, and/or the processing module(s) 401, and/or the processor(s) 404, and/or the determining module(s) are operative, or configured, to determine, based on the received reporting information, regarding said application of the trained ML model.

The network node(s) 400, and/or the processing module(s) 401, and/or the processor(s) 404, and/or the I/O module(s) 405, and/or the sending module(s) may be further operative, or configured, to send, to the first wireless device 120 in response to the determination regarding application of the trained ML model, said instructing information.

The network node(s) 400, and/or the processing module(s) 401, and/or the processor(s) 404, and/or the I/O module(s) 405, and/or the receiving module(s) may be further operative, or configured, to receive, from the first wireless device 120 in response to the sent instructing information, prediction based information.

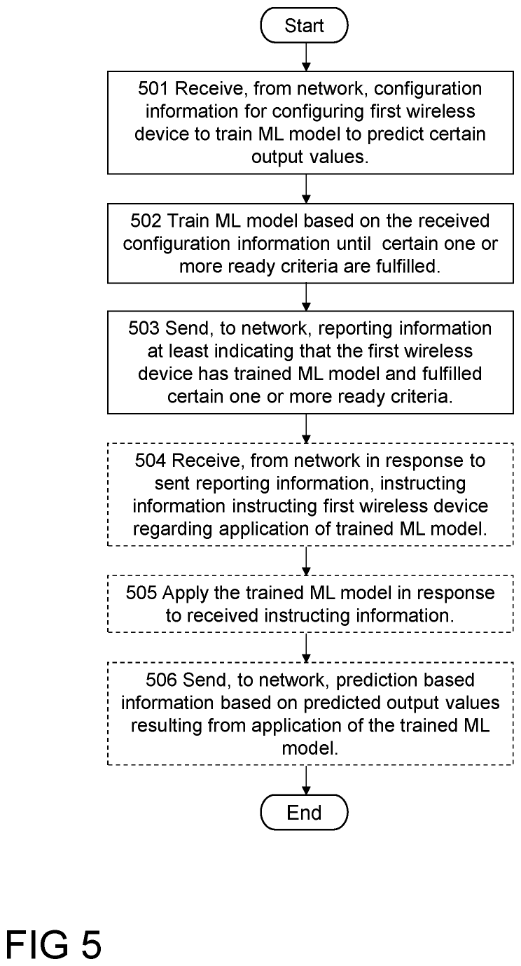

FIG. 5 is a flowchart schematically illustrating embodiments of a method according to embodiments herein. The method is for supporting value prediction by a first wireless device when being served by a wireless communication network. In the following, the first wireless device will be exemplified by the first wireless device 120 and the wireless communication network will be exemplified by the wireless communication network 100.

The method is performed by the first wireless device 120.

The actions below that may form the method may be taken in any suitable order and/or be carried out fully or partly overlapping in time when this is possible and suitable.

### Action 501

The first wireless device 120 receives, from one or more network nodes of the wireless communication network 100, e.g. from the first radio network node 110, configuration information for configuring the first wireless device 120 to, during operation with the wireless communication network 100 train a machine learning, ML, model to predict certain output values. The training uses certain input training data that at least partly are determined by operative conditions of the first wireless device 120 and uses certain desired output values with the input training data. The training ends when the ML model being trained fulfills certain one or more ready criteria.

The configuration information may identify one or more of the following:
the ML model to be trained, at least part of the input training data to be used during the training,
one or more of the desired output values to be used during the training, one or more of said ready criteria,
one or more training stop or paus criteria, one or more parameters of other trained ML models that have been trained by one or more other, second wireless devices, e.g. the second wireless device 121 and/or 122, and which other trained ML models are compatible with and based on the same type of parameters as the ML model subject for the training by the first wireless device 120.

In some embodiments, at least part of the desired output values are provided during the training by the first wireless device 120 according to a first functionality for providing output values.

In some embodiments, the output values may be values for forming information that the first wireless device 120 is configured to transmit to the wireless communication network 100 when operating with the wireless communication network 100. The output values may be values for use by the wireless communication network 100 for serving the first wireless device 120.

The output values may relate to one or more of the following:
allocation of resources for transmission in the uplink and/or downlink,
scheduling of resources in the uplink and/or downlink,
handover regarding the first wireless device 120.

The ready criteria may relate to accuracy of predicted output values and/or to timely provision of predicted output values.

In some embodiments, the ready criteria relate provision of the predicted output values to provision of actual output values provided by the first wireless device 120 according to a first functionality, e.g. the first functionality mentioned above.

The present action may fully or partly correspond to Action 202.

### Action 502

The first wireless device 120 trains the ML model based on the received configuration information until said certain one or more ready criteria are fulfilled.

The present action may fully or partly correspond to Action 203.

### Action 503

In some embodiments, the first wireless device 120 sends, to one or more network nodes of the wireless communication network 100, e.g. the radio network node 110, reporting information at least indicating that the first wireless device 120 has trained the ML model and fulfilled said certain one or more ready criteria. In some embodiments. said reporting information identifies one or more of the following: accuracy obtained by the trained ML model, one or more model parameters of the trained ML model, the trained ML model.

The present action may fully or partly correspond to Action 204.

### Action 504

In some embodiments, the first wireless device 120 receives, from one or more network nodes of the wireless communication network 100, e.g. the radio network node 110, in response to the sent reporting information, instructing information instructing the first wireless device 120 regarding application of the trained ML model.

Said instructing information may relate to one or more of the following:
instructing the first wireless device 120 to apply the ML model and thereby provide predicted output values accordingly,
instructing the first wireless device 120 regarding when to apply the trained ML model,
instructing the first wireless device 120 to provide output values additionally or alternatively according to another functionality,
instructing the first wireless device 120 to retrain the ML model.

The instructing information may further identify one or more of the following:
one or more model parameters of another second trained ML model, comprised in said other trained ML models, for replacing corresponding one or more model parameters of said ML model trained by the first wireless device 120,
another second trained ML model, comprised in said other trained ML models, for replacing said ML model trained by the first wireless device 120.

The present action may fully or partly correspond to Action 206.

### Action 505

In some embodiments where the instructing information instructs the first wireless device 120 to apply the trained ML model, the first wireless device 120 applies, in response to the received instructing information, the trained ML model, thereby providing predicted output values.

The present action may fully or partly correspond to Action 207.

### Action 506

Further, in embodiments where Action 505 is performed, the first wireless device 120 sends, to one or more network nodes of the wireless communication network 100, e.g. the radio network node 110, prediction based information. The prediction based information being information based on said predicted output values resulting from application of the trained ML model.

The present action may fully or partly correspond to Action 208.

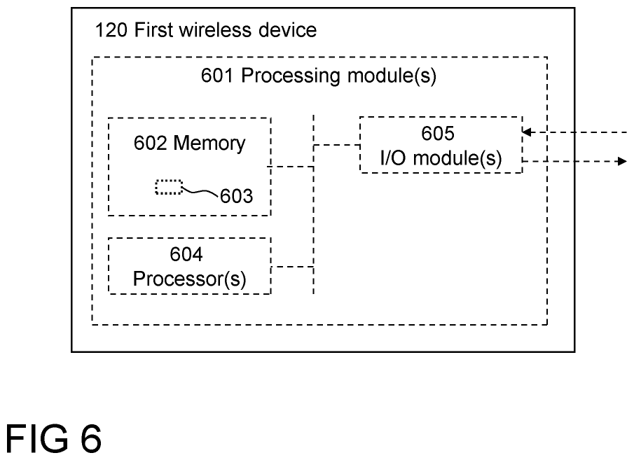

FIG. 6 is a schematic block diagram for illustrating embodiments of how the first wireless device 120 may be configured to perform the method and actions discussed above in connection with FIG. 5. Hence, the first wireless device 120 is for supporting value prediction by the first wireless device 120 served by the wireless communication network 100.

The first wireless device 120 may comprise processing module(s) 601, such as a means, one or more hardware modules, including e.g. one or more processors, and/or one or more software modules for performing said method and/or actions.

The first wireless device 120 may further comprise memory 602 that may comprise, such as contain or store, computer program(s) 603. The computer program(s) 603 comprises ‘instructions’ or ‘code’ directly or indirectly executable by the first wireless device 120 to perform said method and/or actions. The memory 602 may comprise one or more memory units and may further be arranged to store data, such as configurations and/or applications involved in or for performing functions and actions of embodiments herein.

Moreover, the first wireless device 120 may comprise processor(s) 604, i.e. one or more processors, as exemplifying hardware module(s) and may comprise or correspond to one or more processing circuits. In some embodiments, the processing module(s) 601 may comprise, e.g. ‘be embodied in the form of’ or ‘realized by’ processor(s) 604. In these embodiments, the memory 602 may comprise the computer program 603 executable by the processor(s) 604, whereby the first wireless device 120 is operative, or configured, to perform said method and/or actions thereof.

Typically the first wireless device 120, e.g. the processing module(s) 601, comprises Input/Output (I/O) module(s) 605, configured to be involved in, e.g. by performing, any communication to and/or from other network nodes and/or units and/or devices, such as sending and/or receiving information to and/or from other network nodes. The I/O module(s) 605 may be exemplified by obtaining, e.g. receiving, module(s) and/or providing, e.g. sending, module(s), when applicable.

Further, in some embodiments, the first wireless device 120, e.g. the processing module(s) 601, comprises one or more of an sending module(s), receiving module(s), training module(s), applying module(s), as exemplifying hardware and/or software module(s) for carrying out actions of embodiments herein. These modules may be fully or partly implemented by the processor(s) 604.

### Hence:

The first wireless device 120, and/or the processor(s) 604, and/or the I/O module(s) 605, and/or the receiving module(s) are operative, or configured, to receive, from one or more network nodes of the wireless communication network 100, said configuration information.

The first wireless device 120, and/or the processor(s) 604, and/or the training module(s) are operative, or configured, to train the ML model based on the received configuration information until said certain one or more ready criteria are fulfilled.

The first wireless device 120, and/or the processor(s) 604, and/or the I/O module(s) 605, and/or the sending module(s) are operative, or configured, to send, to one or more network nodes of the wireless communication network 100, said reporting information.

The first wireless device 120, and/or the processor(s) 604, and/or the I/O module(s) 605, and/or the receiving module(s) may be operative, or configured, to receive, from one or more network nodes of the wireless communication network 100 in response to the sent reporting information, said instructing information.

The first wireless device 120, and/or the processor(s) 604, and/or the applying module(s) may be operative, or configured, to apply, in response to the received instructing information, said trained ML model.

The first wireless device 120, and/or the processor(s) 604, and/or the I/O module(s) 605, and/or the sending module(s) may be operative, or configured, to send, to one or more network nodes of the wireless communication network 100, said prediction based information.

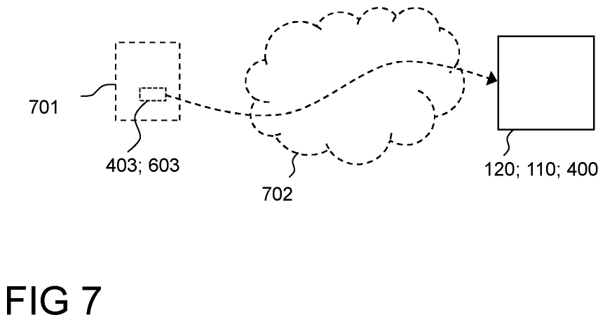

FIG. 7 is a schematic drawing illustrating some embodiments relating to computer program(s) and carriers thereof to cause said network node(s) 400 and first wireless device 120 discussed above to perform said methods, respectively, and related actions. The computer program(s) may be one or more of the computer programs 403, 603, and comprises instructions that when executed by the processor(s) 404, 604 and/or the processing module(s) 401, 601, cause the network node(s) 400 and first wireless device 120 to perform as described above. In some embodiments there is provided carrier(s), or more specifically data carrier(s), e.g. computer program product(s), comprising the computer program(s). Each carrier may be one of an electronic signal, an optical signal, a radio signal, and a computer readable storage medium, e.g. a computer readable storage medium or media 701 as schematically illustrated in the figure. The computer program(s) 403, 603 may thus be stored on such computer readable storage medium 701. By carrier may be excluded a transitory, propagating signal and the data carrier may correspondingly be named non-transitory data carrier. Non-limiting examples of the data carrier(s) being computer readable storage medium or media is a memory card or a memory stick, a disc storage medium, or a mass storage device that typically is based on hard drive(s) or Solid State Drive(s) (SSD). The computer readable storage medium or media 701 may be used for storing data accessible over a computer network 702, e.g. the Internet or a Local Area Network (LAN). The computer program(s) 403, 603 may furthermore be provided as pure computer program(s) or comprised in a file or files. The file or files may be stored on the computer readable storage medium or media 701 and e.g. available through download e.g. over the computer network 702 as indicated in the figure, e.g. via a server. The file or files may e.g. be executable files for direct or indirect download to and execution on said network node(s) 400 and/or first wireless device 120 to make it or them perform as described above, e.g. by execution by the processor(s) 404, 604. The file or files may also or alternatively be for intermediate download and compilation involving the same or another processor(s) to make them executable before further download and execution causing said network node(s) 400 and first wireless device 120 to perform as described above.

Note that any processing module(s) and circuit(s) mentioned in the foregoing may be implemented as a software and/or hardware module, e.g. in existing hardware and/or as an Application Specific Integrated Circuit (ASIC), a field-programmable gate array (FPGA) or the like. Also note that any hardware module(s) and/or circuit(s) mentioned in the foregoing may e.g. be included in a single ASIC or FPGA, or be distributed among several separate hardware components, whether individually packaged or assembled into a System-on-a-Chip (SoC).

Those skilled in the art will also appreciate that the modules and circuitry discussed herein may refer to a combination of hardware modules, software modules, analogue and digital circuits, and/or one or more processors configured with software and/or firmware, e.g. stored in memory, that, when executed by the one or more processors may make any node(s), device(s), apparatus(es), network(s), system(s), etc. to be configured to and/or to perform the above-described methods and actions.

Identification by any identifier herein may be implicit or explicit. The identification may be unique in a certain context, e.g. in the wireless communication network or at least in a relevant part or area thereof.

The term “network node” or simply “node” as used herein may as such refer to any type of node that may communicate with another node in and be comprised in a communication network, e.g. Internet Protocol (IP) network or wireless communication network. Further, such node may be or be comprised in a radio network node (described below) or any network node, which e.g. may communicate with a radio network node. Examples of such network nodes include any radio network node, a core network node, Operations & Maintenance (O&M), Operations Support Systems (OSS), Self Organizing Network (SON) node, etc.

The term “radio network node” as may be used herein may as such refer to any type of network node for serving a wireless communication device, e.g. a so called User Equipment or UE, and/or that are connected to other network node(s) or network element(s) or any radio node from which a wireless communication device receives signals from. Examples of radio network nodes are Node B, Base Station (BS), Multi-Standard Radio (MSR) node such as MSR BS, eNB, eNodeB, gNB, network controller, RNC, Base Station Controller (BSC), relay, donor node controlling relay, Base Transceiver Station (BTS), Access Point (AP), New Radio (NR) node, transmission point, transmission node, node in distributed antenna system (DAS) etc.

Each of the terms “wireless communication device”, “wireless device”, “user equipment” and “UE”, as may be used herein, may as such refer to any type of wireless device arranged to communicate with a radio network node in a wireless, cellular and/or mobile communication system. Examples include: target devices, device to device UE, device for Machine Type of Communication (MTC), machine type UE or UE capable of machine to machine (M2M) communication, Personal Digital Assistant (PDA), tablet, mobile, terminals, smart phone, Laptop Embedded Equipment (LEE), Laptop Mounted Equipment (LME), Universal Serial Bus (USB) dongles etc.

While some terms are used frequently herein for convenience, or in the context of examples involving other a certain, e.g. 3GPP or other standard related, nomenclature, it must be appreciated that such term as such is non-limiting

Also note that although terminology used herein may be particularly associated with and/or exemplified by certain communication systems or networks, this should as such not be seen as limiting the scope of the embodiments herein to only such certain systems or networks etc.

As used herein, the term “memory” may refer to a data memory for storing digital information, typically a hard disk, a magnetic storage, medium, a portable computer diskette or disc, flash memory, random access memory (RAM) or the like. Furthermore, the memory may be an internal register memory of a processor.

Also note that any enumerating terminology such as first device or node, second device or node, first base station, second base station, etc., should as such be considered non-limiting and the terminology as such does not imply a certain hierarchical relation. Without any explicit information in the contrary, naming by enumeration should be considered merely a way of accomplishing different names.

As used herein, the expression “configured to” may e.g. mean that a processing circuit is configured to, or adapted to, by means of software or hardware configuration, perform one or more of the actions described herein.

As used herein, the terms “number” or “value” may refer to any kind of digit, such as binary, real, imaginary or rational number or the like. Moreover, “number” or “value” may be one or more characters, such as a letter or a string of letters. Also, “number” or “value” may be represented by a bit string.

As used herein, the expression “may” and “in some embodiments” has typically been used to indicate that the features described may be combined with any other embodiment disclosed herein.

In the drawings, features that may be present in only some embodiments are typically drawn using dotted or dashed lines.

As used herein, the expression “transmit” and “send” are typically interchangeable. These expressions may include transmission by broadcasting, uni-casting, group-casting and the like. In this context, a transmission by broadcasting may be received and decoded by any authorized device within range. In case of unicasting, one specifically addressed device may receive and encode the transmission. In case of group-casting, e.g. multicasting, a group of specifically addressed devices may receive and decode the transmission.

When using the word “comprise” or “comprising” it shall be interpreted as nonlimiting, i.e. meaning “consist at least of”.

The embodiments herein are not limited to the above described preferred embodiments. Various alternatives, modifications and equivalents may be used. Therefore, the above embodiments should not be taken as limiting the scope of the present disclosure, which is defined by the appending claims.

1. A method, performed by one or more network nodes, for supporting value prediction by a first wireless device being served by a wireless communication network, the method comprising:
sending, to the first wireless device, configuration information for configuring the first wireless device to, during operation with the wireless communication network, train a machine learning, ML, model to predict certain output values, the training uses using certain input training data that at least partly are determined by operative conditions of the first wireless device and using certain desired output values with the input training data, the training ending when the ML model being trained fulfills certain one or more ready criteria;
receiving, from the first wireless device, reporting information at least indicating that the first wireless device has trained the ML model and fulfilled the certain one or more ready criteria; and
determining, based on the received reporting information, regarding application of the trained ML model, the ready criteria relating provision of the predicted output values to provision of actual output values provided by the first wireless device according to a first functionality.

2. The method as claimed in claim 1, wherein the method further comprises:
sending, to the first wireless device in response to the determination regarding application of the trained ML model, instructing information instructing the first wireless device regarding application of the trained ML model.

3. The method as claimed in claim 2, wherein the instructing information instructs the first wireless device to apply the trained ML model, and wherein the method further comprises:
receiving, from the first wireless device in response to the sent instructing information, prediction based information being information based on predicted output values resulting from application of the trained ML model by the first wireless device.

4. The method as claimed in claim 1, wherein the configuration information identifies one or more of the following: the ML model to be trained, at least part of the input training data to be used during the training, one or more of the desired output values to be used during the training, one or more of the ready criteria, one or more training stop or paus criteria, one or more parameters of other trained ML models that have been trained by one or more other, second wireless devices and which other trained ML models are compatible with and based on the same type of parameters as the ML model subject for the training by the first wireless device.

5. The method as claimed in claim 1, wherein at least part of the desired output values are provided during the training by the first wireless device according to a first functionality for providing output values.

6. The method as claimed in claim 1, wherein the output values are values for forming information that the first wireless device is configured to transmit to the wireless communication network when operating with the wireless communication network.

7. The method as claimed in claim 6, herein the output values are values for use by the wireless communication network for serving the first wireless device.

8. The method as claimed in claim 1, wherein the output values relate to one or more of the following: allocation of resources for transmission in one or both of the uplink and the downlink, scheduling of resources in the one of the uplink and the downlink, handover regarding the first wireless device.

9. The method as claimed in claim 1, wherein the ready criteria relate to accuracy of predicted output values.

10. The method as claimed in claim 1, wherein the ready criteria relate to timely provision of predicted output values.

11. (canceled)

12. The method as claimed in claim 1, wherein the reporting information identifies one or more of the following: accuracy obtained by the trained ML model, one or more model parameters of the trained ML model, the trained ML model.

13. The method as claimed in claim 1, wherein the determination regarding application of the trained ML model and the instructing information relate to one or more of the following: instructing the first wireless device to apply the ML model and thereby provide predicted output values accordingly, instructing the first wireless device regarding when to apply the trained ML model, instructing the first wireless device to provide output values additionally or alternatively according to another functionality, instructing the first wireless device to retrain the ML model.

14. The method as claimed in claim 1, wherein the determination regarding application of the trained ML model is further based on other reporting information that the one or more network nodes have received from one or more second wireless devices relating to one or more other trained ML models that have been trained by the second wireless devices, respectively.

15. The method as claimed in claim 14, wherein the instructing information identifies one or more of the following:
one or more model parameters of another second trained ML model, comprised in the other trained ML models, for replacing corresponding one or more model parameters of the ML model trained by the first wireless device; and
another second trained ML model, comprised in the other trained ML models, for replacing the ML model trained by the first wireless device.

16. (canceled)

17. (canceled)

18. A method, performed by a first wireless device, for supporting value prediction by the first wireless device, the first wireless device being served by a wireless communication network, wherein the method comprises:
receiving, from one or more network nodes of the wireless communication network, configuration information for configuring the first wireless device to, during operation with the wireless communication network, train a machine learning, ML, model to predict certain output values, the training using certain input training data that at least partly are determined by operative conditions of the first wireless device and using certain desired output values with the input training data, the training ending when the ML model being trained fulfills certain one or more ready criteria;
training the ML model based on the received configuration information until the certain one or more ready criteria are fulfilled; and
sending, to one or more network nodes of the wireless communication network, reporting information at least indicating that the first wireless device has trained the ML model and fulfilled the certain one or more ready criteria, the ready criteria relating provision of the predicted output values to provision of actual output values provided by the first wireless device according to a first functionality.

19. The method as claimed in claim 18, wherein the method further comprises:
receiving, from one or more network nodes of the wireless communication network in response to the sent reporting information, instructing information instructing the first wireless device regarding application of the trained ML model.

20. The method as claimed in claim 19, wherein the instructing information instructs the first wireless device to apply the trained ML model, and wherein the method further comprises:
applying, in response to the received instructing information, the trained ML model, thereby providing predicted output values; and
sending, to one or more network nodes of the wireless communication network, prediction based information being information based on the predicted output values resulting from application of the trained ML model.

21. The method as claimed in claim 18, wherein the configuration information identifies one or more of the following: the ML model to be trained, at least part of the input training data to be used during the training, one or more of the desired output values to be used during the training, one or more of the ready criteria, one or more training stop or paus criteria, one or more parameters of other trained ML models that have been trained by one or more other, second wireless devices and which other trained ML models are compatible with and based on the same type of parameters as the ML model subject for the training by the first wireless device.

22.-33. (canceled)

34. One or more network nodes for supporting value prediction by a first wireless device being served by a wireless communication network, the one or more network nodes being configured to:
send, to the first wireless device, configuration information for configuring the first wireless device to, during operation with the wireless communication network, train a machine learning, ML, model to predict certain output values, the training using certain input training data that at least partly are determined by operative conditions of the first wireless device and using certain desired output values with the input training data, the training ending when the ML model being trained fulfills certain one or more ready criteria;
receive, from the first wireless device, reporting information at least indicating that the first wireless device has trained the ML model and fulfilled the certain one or more ready criteria; and
determine, based on the received reporting information, regarding application of the trained ML model, the ready criteria relating provision of the predicted output values to provision of actual output values provided by the first wireless device according to a first functionality.

35.-48. (canceled)

49. A first wireless device for supporting value prediction by the first wireless device when the first wireless device is being served by a wireless communication network, the first wireless device s being configured to:
receive, from one or more network nodes of the wireless communication network, configuration information for configuring the first wireless device to, during operation with the wireless communication network, train a machine learning, ML, model to predict certain output values, the training using certain input training data that at least partly are determined by operative conditions of the first wireless device and using certain desired output values with the input training data, and wherein the training ends when the ML model being trained fulfills certain one or more ready criteria;
train the ML model based on the received configuration information until the certain one or more ready criteria are fulfilled; and
send, to one or more network nodes of the wireless communication network, reporting information at least indicating that the first wireless device has trained the ML model and fulfilled the certain one or more ready criteria, the ready criteria relating provision of the predicted output values to provision of actual output values provided by the first wireless device according to a first functionality.

50.-62. (canceled)
